(19) United States
(12) Patent Application Publication
(10) Pub. No.: US 2005/0040171 A1
(43) Pub. Date: Feb. 24, 2005

(54) Multi clad cookware

(75) Inventor: Prakasa Alim, Surabaya (ID)

Correspondence Address: BANNER & WITCOFF, LTD., TEN SOUTH WACKER DRIVE, SUITE 3000, CHICAGO, IL, 60606, US

(73) Assignee: P.T. Maspion, Surabaya (ID)

(21) Appl. No.: 10/644,193

(22) Filed: Aug. 20, 2003

(51) Int. Cl. A47J 27/00

(52) U.S. Cl. 220/573.1

(57) ABSTRACT

A cooking utensil comprising a first layer cooking surface, the first layer formed from a flat sheet of stainless steel; a second layer beneath the first layer, the second layer formed from a flat sheet of aluminum and thermally bonded with the first layer; and a third layer formed from a sheet of stainless steel and thermally bonded with the second layer. The third layer includes a plurality of perforations into which some of the second layer extends, the third layer directly contacting a heat source and allowing direct contact between the heat source and the second layer.

### FIELD OF THE INVENTION

The present invention relates to cookware, and, in particular, to cookware with multi clad layers and perforated layers.

### BACKGROUND OF THE INVENTION

Prior art stainless steel cooking surfaces suffer from the drawback that stainless steel does not heat evenly over the entire cooking surface. The areas of the stainless steel surface in direct contact with the heat source become hotter than the areas of the stainless steel surface not in direct contact with the heat source. As a result, food items are not heated and cooked evenly and can burn.

Copper and aluminum have better thermal conductivity and thus offer better heat distribution than stainless steel. Thus, prior art cookware has included aluminum or copper plates thermally bonded to the bottom surface of stainless steel cookware. Sometimes such aluminum or copper plates are covered with a layer of stainless steel to improve the appearance of the cookware. However, this layer of stainless steel can result in uneven heating and cooking.

Cooking utensils with a base made of a composite structure are also known in the art. Such bases may include a layer of aluminum and a layer of stainless steel. The stainless steel layer may include perforations that allow the aluminum to be flush with the steel layer and in direct contact with a hearing source, as described for example, in U.S. Pat. No. 6,422,233, which is incorporated by reference. However, such utensils do not offer the benefits of multi clad layers throughout the cookware, including in the cookware walls.

### SUMMARY OF THE INVENTION

The invention is directed to a cooking utensil comprising a first layer. The first layer is a cooking surface and is formed from a sheet of metal. The invention further comprises a second layer beneath the first layer. The second layer is formed from a sheet of metal and is thermally bonded with the first layer. The invention further comprises a third layer formed from a sheet of metal and thermally bonded with the second layer. The third layer includes a plurality of perforations into which some of the second layer extends. The third layer directly contacts a heat source and allowing direct contact between the heat source and the second layer. The first, second and third layers extend continuously along a substantially horizontal portion of the utensil and along a substantially vertical annular wall of the utensil.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a cross section of a cooking utensil in accordance with the present invention.

FIG. 2 shows a bottom view of cooking utensil of FIG. 1.

FIG. 3 shows a cross section of another embodiment of a cooking utensil in accordance with the present invention.

### DETAILED DESCRIPTION

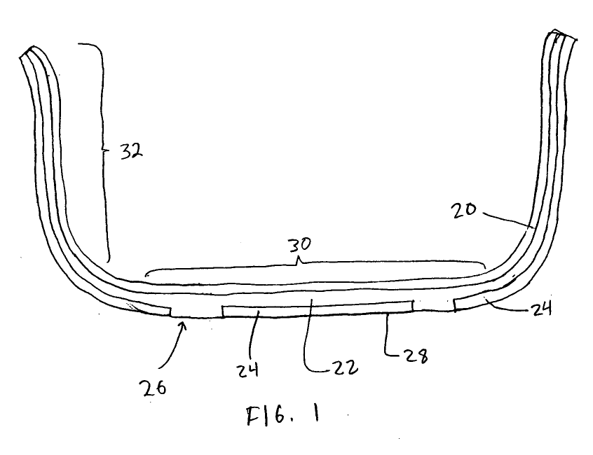

FIGS. 1-3 shows various embodiments of a cooking utensil in accordance with the invention. FIG. 1 shows a cooking utensil that includes a metal layer or cooking surface 20. The metal surface is preferably stainless steel. A metal layer 22 is situated beneath the surface 20. The metal layer 22 is preferably aluminum. A metal layer 24 is situated beneath the surface 20 and the metal layer 22. The metal layer 24 is preferably stainless steel and includes perforations, as shown, for example, at arrow 26.

The layer 22 extends between the layer 20 and the layer 24 along the entire length of the layers 20 and 24. The pot shown in FIG. 1 includes a substantially horizontal portion 30 and a substantially vertical annular side wall 32 that extends substantially perpendicular from the surface 30. The layer 22 extends continuously along the substantially horizontal surface 30 and along the substantially vertical annular side wall 32 between the surface 20 and the surface 24.

As is known to one skilled in the art, the multil clad cooking utensil is formed by rolling the materials together in a flat sheet. Specifically, steel, aluminum and perforated steel layers are rolled together. They layers are then thermally formed. During that process the aluminum plate 22 extends into the perforations, for example as shown at 26, in the bottom layer 22. Portions of the aluminum layer 22 are thus flush with the bottom surface 28 of the plate 24. The formed layers are then shaped to the form of the cookware.

FIG. 1 shows a pot, but the invention could also be directed to other cookware, such as a pan. In alternative embodiments, the layers 20, 22 and 24 are formed of other metals. In one alternative embodiment, the layer 20 is copper, the layer 22 is aluminum and the layer 24 is stainless steel. In another alternative, the layer 20 is stainless steel, the layer 22 is aluminum and the layer 24 is copper.

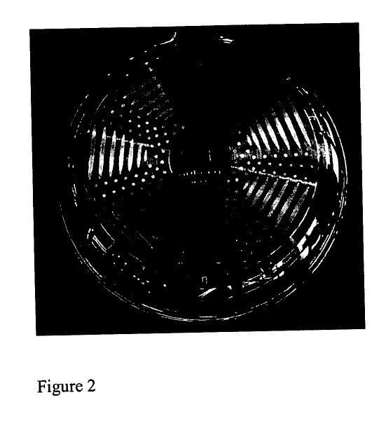

FIG. 2 shows a bottom view of the utensil of FIG. 1. Multiple perforations are illustrated in this figure.

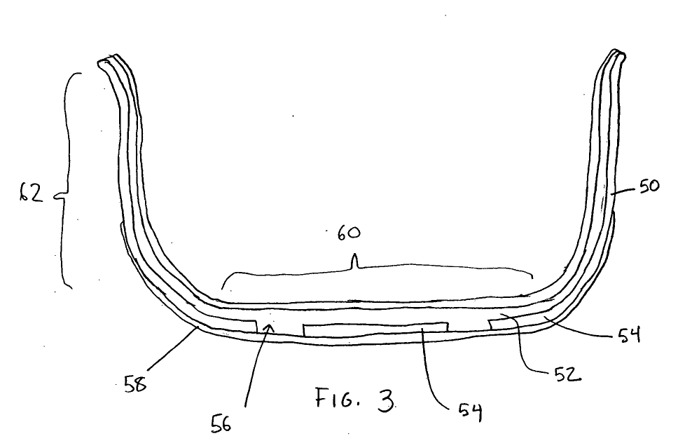

FIG. 3 shows a cooking utensil with four layers. The cooking utensil includes a metal layer 50. The metal layer 50 is preferably stainless steel. A metal layer 52 is situated beneath the portion 50. The metal layer 52 is preferably aluminum. A metal layer 54 is situated beneath the layer 50 and the layer 52. The layer 54 is preferably stainless steel and includes perforations, as shown, for example, at arrow 56. A metal surface 58 extends over a portion of the layer 54. The surface 58 is a copper metal that is transferred to the surface via an anode/cathode plating process, as is known to one skilled in the art.

The metal layers 50, 52, 54 run continuously along the substantially horizontal portion 60 of the utensil and along the substantially vertical annular wall 62 of the utensil. The metal layers 50, 52, 54 can be formed from other metals, for example as described in the section regarding FIG. 1.

The invention is embodied in the form shown in the various drawings. Numerous variations are possible while maintaining the spirit of the invention. For example, the invention can consist of more than three layers of material. Such variations are contemplated as being part of the present invention

1. A cooking utensil comprising a substantially horizontal portion and a substantially vertical annular wall comprising:
a first layer cooking surface, the first layer formed from a sheet of stainless steel and extending continuously along the substantially horizontal surface and along the annular vertical wall;
a second layer beneath the first layer, the second layer formed from a sheet of aluminum and thermally bonded with the first layer, the second layer extending continuously along the substantially horizontal surface and along the annular vertical wall;
a third layer formed from a sheet of stainless steel and thermally bonded with the second layer, the third layer extending continuously along the substantially horizontal surface and along the annular vertical wall; and
the third layer including a plurality of perforations into which some of the second layer extends, the third layer directly contacting a heat source and allowing direct contact between the heat source and the second layer at the perforations.

2. The cooking utensil of claim 1, wherein the perforations are round.

3. The cooking utensil of claim 1, wherein the perforations are elliptical.

4. A cooking utensil comprising:
a first layer cooking surface, the first layer comprised of stainless steel;
a second layer between the first layer and a third layer, the second layer comprised of aluminum;
the third layer between the second layer and a fourth layer, the third layer comprised of stainless steel; and
a fourth layer comprised of copper, the fourth layer formed by copper plating and the fourth layer directly contacting a heat source.

5. The cooking utensil of claim 4 wherein the first, second and third layers extend continuously along a substantially horizontal portion and a substantially vertical annular wall.

6. A cooking utensil comprising:
an annular wall portion;
a bottom portion;
a first layer comprising a cooking surface, a second layer and a third layer, each of the first, second and third layers extending continuously along the annular wall portion and the bottom portion; and
the third layer comprising perforations into which the second layer extends.

7. The cooking utensil of claim 6 wherein the first layer is stainless steel, the second layer is aluminum and the third layer is stainless steel.

8. The cooking utensil of claim 6 wherein the first layer is copper, the second layer is aluminum and the third layer is stainless steel.

9. The cooking utensil of claim 6 wherein the first layer is stainless steel, the second layer is aluminum and the third layer is copper.

10. The cooking utensil of claim 7 wherein the utensil is formed from rolled layers of stainless steel, aluminum and stainless steel thermally bonded and formed.
